(19) United States
(12) Patent Application Publication
(10) Pub. No.: US 2026/0016375 A1
(43) Pub. Date: Jan. 15, 2026

(54) SYSTEMS AND METHODS OF MANAGING A PRODUCTION LINE IN A DEGRADED MODE

(71) Applicant: AdeptAG, Oberlin, OH (US)

(72) Inventors: Kevin David MENICE, Millis, MA (US); Kane Daniel HOGAN, Rocky River, OH (US); Alan Lee GIRARD, Olmsted Falls, OH (US)

(21) Appl. No.: 19/266,744

(22) Filed: Jul. 11, 2025

Related U.S. Application Data
(60) Provisional application No. 63/670,384, filed on Jul. 12, 2024.

(51) Int. Cl. G01M 99/00

(52) U.S. Cl. CPC G01M 99/005

(57) ABSTRACT

A device may detect a problem with one machine in a production line comprising a set of disparate machines to yield a detected problem. A device may, based on the detected problem, determine, via an artificial intelligence model or rule chain and for a respective machine on the production line, a respective correct degraded mode for the respective machine in order to maintain a constant and a degraded production line output. A device may issue a series of commands such that a respective machine adjusts to the respective correct degraded mode and the production line operates to produce the degraded production line output.

### PRIORITY INFORMATION

The present application claims the benefits of U.S. Patent Provisional Application No. 63/670,384, filed Jul. 12, 2024, the contents of which are incorporated herein by reference in their entirety.

### FIELD OF THE DISCLOSURE

Aspects of the present disclosure generally relate to agricultural equipment and, more specifically, to systems and methods of enabling the maintenance and repair of agricultural equipment in novel and more efficient ways. The approach also includes issuing a series of commands, based on a condition, such that a respective machine of a production line adjusts to a degraded mode and the production line operates to produce a degraded production line output.

### BACKGROUND

The present disclosure generally relates to the management of agricultural equipment. The Controlled Environment Agriculture (CEA) industry is comprised of many small to medium-sized vendors that supply different types of automation, irrigation, and control systems to growers. Vendors operate independently to provide solutions to a particular challenge or problem. Vendors are based in Holland, Spain, Italy, the US, and Canada. European Union (EU) based vendors have a difficult time supporting the equipment they send to North America. The vendors are often too small to establish a major service presence across the expanse of North America.

As a result of the above issue, a grower can have an array of equipment from many vendors. Some equipment is sophisticated, with decent fault detection and diagnostic capabilities, and may be cloud-based with remote support. Others are programmable logic controller (PLC) based, have fault detection and diagnostic capabilities, but are not connected, and a grower must be on-premises to determine the health and state of the machine. Finally, equipment such as conveyance systems is simplistic, utilizing relay-based control systems with no fault detection and diagnostic capabilities. Growers are left on their own to manage the production output, maintenance, and repair of their equipment.

The current approach presents a few problems. First, the grower's maintenance team must know how each machine in their production line operates and how to retrieve fault and diagnostic information from each machine. Next, machines do not offer preventative maintenance reminders. If preventive maintenance routines exist for the equipment, they are typically in the equipment manual, which is easy to lose or forget about. Indicators for where a piece of equipment is relative to a preventative maintenance plan are non-existent, difficult to find, and if available, inconsistent. Further, the grower has poor visibility into the state of their production lines. In the event of a catastrophic production line issue, this prevents them from redirecting production to another line, resulting in lost output. It also prevents them from doing maintenance or repairs during downtime, resulting in lost output or expensive emergency repairs. Finally, as a note, it is hard to find and retain qualified technicians to maintain and repair equipment as needed. Growers typically let their machines run until they break.

### SUMMARY

The disclosed approach addresses the issues raised above. By getting real-time notifications of issues, the disclosed system can proactively schedule repairs or maintenance. It can also run equipment in a degraded mode. The approach takes advantage of whatever runtime production, fault, and diagnostic information is available for a machine. The approach includes augmenting machines with sensors that were not designed to transmit fault data to a remote server, and connecting the machines and sensors in such a way that the information is transmitted to a central server for processing. A grower can thereby obtain a complete picture of how their grow and production rooms or other machines are functioning. By augmenting the data with recommended or industry best practice preventative maintenance, the grower can extend the life of their equipment and avoid costly repairs during peak production runs.

There are a number of advantages to this new approach. The approach avoids production disruption during peak hours, resulting in lost output and dissatisfied customers. The approach can avoid costly off-hour repairs when equipment faults occur and must be immediately fixed. The approach can provide detailed fault and repair information, making repairs much more efficient. The approach provides real-time visibility of production metrics versus what production is planned. The approach can provide visibility so that production can be redirected to another line if one is available, and extend the life of the equipment. The approach can also give a company or service entity real-time visibility to schedule repairs quickly and efficiently. No company in the CEA space provides such capabilities.

The disclosed systems (i.e., any one or more of a computing system 500, an edge controller, a network server, a cloud-based server, a sensor, an IoT device, and/or any component or machine disclosed herein) and methods can aggregate disparate fault and preventative maintenance information from 3^{rd} party machines and present results, status, updates and so forth to a user in one place. The system can be configured to normalize fault/preventative maintenance information from disparate 3^{rd} party machines (i.e., made by different manufacturers) into a consistent information model. The system can intercept data transmitted from a PLC to a human-machine interface (HMI) to retrieve fault and preventative maintenance information from 3^{rd} party machines or from different types of machines not designed to provide such data or to report such data. The system can process fault data using rules engines and/or artificial intelligence to determine and suggest corrective action. The system can include auto-generation of work lists based on fault/preventative maintenance data collected and processed. The system can process input data (fertilizer consumption and other additives) to automatically generate governmental compliance reports. These principles above can be incorporated into any one or more components of a system network or device to enable a novel feature and achieve the practical solution disclosed herein.

In some aspects, the techniques described herein relate to an apparatus including: at least one memory; and at least one processor coupled to the at least one memory and configured to: receive first data from a first sensor or first programmed logic controller configured on a first machine and receive second data from a second sensor or a second programmed logic controller on a second machine; process the first data and the second data via a communication protocol to harmonize and aggregate the first data and the second data at a central server to generate an alert for one of the first machine or the second machine; and perform a repair, preventative maintenance, or run in a degraded mode based on the alert, on one of the first machine or the second machine or provide a notice regarding steps to be taken by a human.

In some aspects, the techniques described herein relate to a method of handling alerts from a plurality of disparate systems including: receiving first data from a first sensor or a first programmed logic controller configured on a first machine and receiving second data from a second sensor or a second programmed logic controller on a second machine, wherein the first machine and the second machine are different types of machines; processing the first data and the second data via a communication protocol to harmonize and aggregate the first data and the second data at a central server to generate an alert for one of the first machine or the second machine; and performing a repair or preventative maintenance, based on the alert, on one of the first machine or the second machine or providing a notice regarding steps to be taken by a human.

In some aspects, the techniques described herein relate to a computer-readable storage medium storing instructions which, when executed by at least one processor coupled to the computer-readable storage medium cause the at least one processor to be configured to: receive first data from a first sensor or a first programmed logic controller configured on a first machine and receiving second data from a second sensor or a second programmed logic controller on a second machine, wherein the first machine and the second machine are different types of machines; process the first data and the second data via a communication protocol to harmonize and aggregate the first data and eth second data at a central server to generate an alert for one of the first machine or the second machine; and perform a repair or preventative maintenance, based on the alert, on one of the first machine or the second machine or provide a notice regarding steps to be taken by a human.

In some aspects, the techniques described herein relate to an apparatus including: at least one memory; and at least one processor coupled to the at least one memory and configured to: capture, on a machine and via a device, data indicative of an alert or error; generate, based on the data indicative of the alert of the error, a data payload on-premises via one or more of the machine, a broker, an edge controller and a gateway; and transmit the data payload to an external server to enable a case to be opened and a service technician to be dispatched to repair or service the machine.

In some aspects, the techniques described herein relate to a method including: capturing, on a machine and via a device, data indicative of an alert or error; generating, based on the data indicative of the alert of the error, a data payload on-premises via one or more of the machine, a broker, an edge controller and a gateway; and transmitting the data payload to an external server to enable a case to be opened and a service technician to be dispatched to repair or service the machine.

In some aspects, the techniques described herein relate to a computer-readable storage medium storing instructions which, when executed by at least one processor coupled to the computer-readable storage medium cause the at least one processor to be configured to: capture, on a machine and via a device, data indicative of an alert or error; generate, based on the data indicative of the alert of the error, a data payload on-premises via one or more of the machine, a broker, an edge controller and a gateway; and transmit the data payload to an external server to enable a case to be opened and a service technician to be dispatched to repair or service the machine.

In some aspects, the techniques described herein relate to a method including: detecting a problem with one machine in a production line including a set of disparate machines to yield a detected problem; based on the detected problem, determine, via an artificial intelligence model or rule chain and for a respective machine on the production line, a respective correct degraded mode for the respective machine in order to maintain a constant and degraded production line output; and issuing a series of commands such that the respective machine adjusts to the respective correct degraded mode and the production line operates to produce the degraded production line output. The approach may also encompass a scenario where a system simply instructs a grower how to degrade their system. Thus, issuing the command may be done in the form of a text, a voicemail, an email or some kind of notification with instructions on how a grower can degrade their system manually or automatically.

In some aspects, the techniques described herein relate to a system including: a production line including a set of disparate machines; a processor; and a computer-readable storage device storing instructions which, when executed by the processor, cause the processor to be configured to: detect a problem with one machine in the production line to yield a detected problem; based on the detected problem, determine, via an artificial intelligence model or rule chain and for a respective machine on the production line, a respective correct degraded mode for the respective machine in order to maintain a constant and degraded production line output; and issue a series of commands such that the respective machine adjusts to the respective correct degraded mode and the production line operates to produce the degraded production line output.

In some aspects, the techniques described herein relate to a method including: detecting a problem with a machine in a production line including a set of disparate machines to yield a detected problem; based on the detected problem, determining, via an artificial intelligence model or rule chain and for a respective machine on the production line, a respective correct degraded mode for the respective machine in order to maintain an original production line output or a degraded production line output; and issuing a series of commands such that the respective machine adjusts to the respective correct degraded mode or the respective machine is bypassed and the production line operates to produce either the original production line output or the degraded production line output.

The respective correct degraded mode can involve reducing a speed or output of a machine to prevent potential failure, thereby extending an operational life of equipment.

In some aspects, the techniques described herein relate to a system including: a production line including a set of disparate machines; a processor; and a computer-readable storage device storing instructions which, when executed by the processor, cause the processor to be configured to: detect a problem with one machine in the production line to yield a detected problem; based on the detected problem, determine, via an artificial intelligence model or rule chain and for a respective machine on the production line, a respective correct degraded mode for the respective machine in order to maintain an original production line output or a degraded production line output; and issue a series of commands such that the respective machine adjusts to the respective correct degraded mode or the respective machine is bypassed and the production line operates to produce either the original production line output or the degraded production line output.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram of an example on-premises alert-propagation architecture, in accordance with the present disclosure.

FIG. 2A illustrates a technician dispatch process flow, in accordance with the present disclosure.

FIG. 2B illustrates a harmonization approach to alert data, in accordance with the present disclosure.

FIG. 2C illustrates a degradation approach to a series of equipment, in accordance with the present disclosure.

FIG. 2D illustrates a degradation approach to a series of equipment, in accordance with the present disclosure.

FIG. 3 illustrates a method of providing a unified view and management of various machines, in accordance with the present disclosure.

FIG. 4A illustrates a method related to dispatching a repair crew to a machine, in accordance with the present disclosure.

FIG. 4B illustrates a method related to degradation modes and operating a production line in a degraded production line output, in accordance with the present disclosure.

FIG. 4C illustrates another method related to degradation modes, in accordance with the present disclosure.

FIG. 5 illustrates an example computing system, in accordance with the present disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

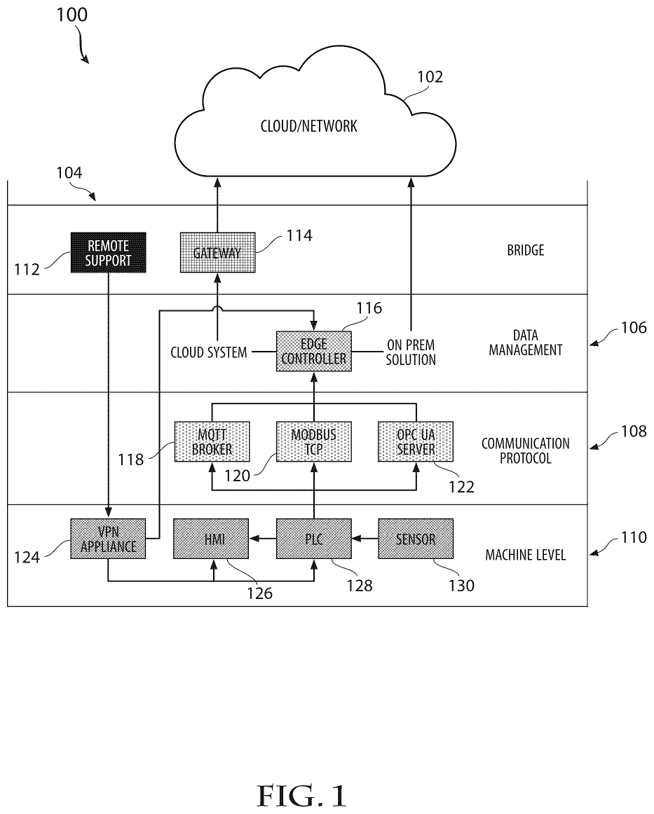

FIG. 1 illustrates an on-premises alert propagation architecture 100. A machine level 110 or machine layer can define the general components built into machines or equipment that needs to connect to the system to enable management of repairs and maintenance. The on-premises alert propagation architecture 100 is required to provide a means for devices (such as a PLC 128, HMI 126 or human-machine interfaces, sensor 130, counter, and other IoT or Internet of Thing devices) to register and to communicate information to computer systems in a cloud computing environment 102 for further processing. A virtual private network (VPN) can be provided with equipment to enable a VPN appliance 124 at the machine level or machine layer. The on-premises alert propagation architecture 100 allows a system to trap and propagate alerts from all the equipment in its portfolio and any vendor machines that generate and can transmit alert information and from added sensors. The rich set of protocols supported provides flexibility to handle most scenarios.

Note that the sensor 130 may also be configured between the PLC 128 and the HMI 126. For some equipment, it may already include a PLC 128 that generates an alert or notice as to some event associated with the machine and transmits that alert to the HMI 126. The HMI 126 may be a display, a light, or an output device that provides a sound or a combination of outputs. The machine may not be built to sense that alteration and generate data to transmit via a VPN appliance 124 to an edge controller 116 for transmission via a gateway 114 to a remote server or cloud computing environment 102 for further processing.

A communication protocol exists between the PLC and HMI (and not a sensor). One of the aspects of this disclosure is to insert a sensor or detector to tap into and pull tagged data out of the communication between the PLC and the HMI. This is not what the PLC to HMI interface was intended to do. Such data is captured for separate processing in a way that the machine was not designed to do.

The equipment can include any type of equipment, such as tractors, mowers, seeding devices, conveyor belts, fixed equipment, mobile equipment, and so forth. The equipment can be from different vendors and have different types of sensors and human-machine interfaces.

In a communication protocol level 108, Many different scenarios can be handled. An MQTT broker 118 can be used to handle messages from the PLC 128. MQTT stands for Message Queues Telemetry Transport. An MQTT protocol can define multiple types of network entities, such as a message broker and several clients. An MQTT broker 118 can be a server that receives all messages from the equipment (of various types and capabilities) and can route the messages to the appropriate device such as an edge controller 116 in a data management level 106. An MQTT client is any device or piece of equipment that runs an MQTT library and connects to the MQTT broker 118 over a network. Information can be organized in a hierarchy of topics. When a piece of equipment has a new item of data to report, the component on the equipment can send a control message with the data to the MQTT broker 118. The MQTT broker 118 then distributes the information to any device that have subscribed to that topic. The equipment that provides the data does not need to have any knowledge on the number or locations of subscribers, and subscribers, in turn, do not have to be configured with any data about the publishers.

The architecture described above is exemplary only. A simpler architecture may be encompassed within this disclosure as well.

If a broker receives a message on a topic for which there are no current subscribers, the broker discards the message unless the publisher of the message designated the message as a retained message. A retained message is a normal MQTT message with the retained flag set to true. The broker stores the last retained message and the corresponding quality of service (Qos) for the selected topic. Each client that subscribes to a topic pattern that matches the topic of the retained message receives the retained message immediately after they subscribe. The broker stores only one retained message per topic. The approach allows new subscribers to a topic to receive the most current value rather than waiting for the next update from a publisher.

When a piece of equipment first connects to the MQTT broker 118, it can set up a default message to be sent to the edge controller 116 if the MQTT broker 118 detects that the equipment has unexpectedly disconnected from the MQTT broker 118. A minimal MQTT control message can be as little as two bytes of data. A control message can carry nearly 256 megabytes of data if needed. In some aspects, there are fourteen defined message types used to connect and disconnect a client from a broker, to publish data, to acknowledge receipt of data, and to supervise the connection between client and server. There may be other message types as well. In some aspects, MQTT relies on the TCP protocol for data transmission. A variant, MQTT-SN, is used over other transports such as UDP (User Datagram Protocol) or Bluetooth or some other wireless protocol. MQTT sends connection credentials in plain text format and does not include any measures for security or authentication. MQTT in some aspects is a one-way communication. As used herein, MQTT may be a one-way communication or may be in some cases a two-way communication with data being transmitted back to the respective machine.

The communication protocol level 108 can also include a Modbus TCP/IP component 120. The Modbus TCP/IP (Transmission Control Protocol/Internet Protocol) protocol can be referred to as the Modbus TCP protocol or just Modbus TCP. The Modbus TCP/IP protocol is a variant of the Modbus family of vendor-neutral communication protocols intended to supervise and control automation equipment. Specifically, the Modbus TCP/IP covers the use of Modbus messaging in an intranet or internet environment using the TCP/IP protocols. The most common use of the protocols currently is for Ethernet attachment of PLCs, I/O (Input/Output) modules, and gateways to other simple field buses or I/O networks.

The communication protocol level 108 can also include an OPC UA server 122 can represent an Object Linking and Embedding Process Control Unified Architecture. The OPC UA server 122 runs a machine-to-machine communication protocol for industrial automation and data exchange. The MQTT broker 118, the Modbus TCP/IP component 120, and the OPC UA server 122 each receive data from the PLC 128 associated with equipment and provide the data to the edge controller 116 at a data management level 106. The data management level 106 provides data via a cloud system to a gateway 114 associated with a bridge level 104, which forwards the data to the cloud computing environment 102. An on-premises solution can be configured at the data management level 106 to provide data to the cloud computing environment 102.

The VPN appliance 124 can provide data to the edge controller 116 as well as to a remote support component 112 in the bridge level 104.

An example on-premises flow can include first identifying a fault with a machine or equipment. A PLC 128 can be configured on the machine to capture the alert and send the alert to the edge controller 116, which can be loaded in a building on a farm, such as a greenhouse, using any one of a variety of protocols as shown in the communication protocol level 108. The protocols may be one-way (as in MQTT) or may be bidirectional. The system determines, for example, that there is an equipment fault with a machine. The machine has a PLC 128, which can capture the alert and send it to the edge computer located in the greenhouse using any one of a variety of protocols. The alert information can be processed, passed to the gateway 114, and sent to a cloud-based server in the cloud computing environment 102 for further processing.

In some aspects, the disclosed system can diagnose a fault and run the machine in a degraded mode. For example, suppose the system detects that a roller bearing is going to fail (caused by noise/vibration picked up by a sensor, or via data from a camera or thermometer or other device). In that case, a rules engine/AI software can decide to slow the machine down so as to prevent the failure, but allow production output. The machine would run in this degraded mode until it was repaired. The degraded mode can mean any mode that includes a reduced set of operations or a simplified set of operations. The degraded mode could also be characterized as a deprecated mode as well. The rules engine can automatically detect this and issue a command to the target machine to operate at a slower rate or to make some other operational adjustment, such as operate at a different temperature or volume of liquid, and so forth.

The capabilities of each machine are stored in a machine descriptor module, so machines can have vastly different capabilities, and the system can handle it.

The approach may also encompass a scenario where a system instructs a grower (i.e., a human grower) how to degrade their system. Thus, issuing the command may be done in the form of a text, a voicemail, an email, via an app, or via a user interface, or some kind of notification with instructions on how a grower can degrade their system manually or automatically. The instructions may identify a particular machine in a production line and what to do to that machine (i.e., reduce output by 20% of the third component in the production line).

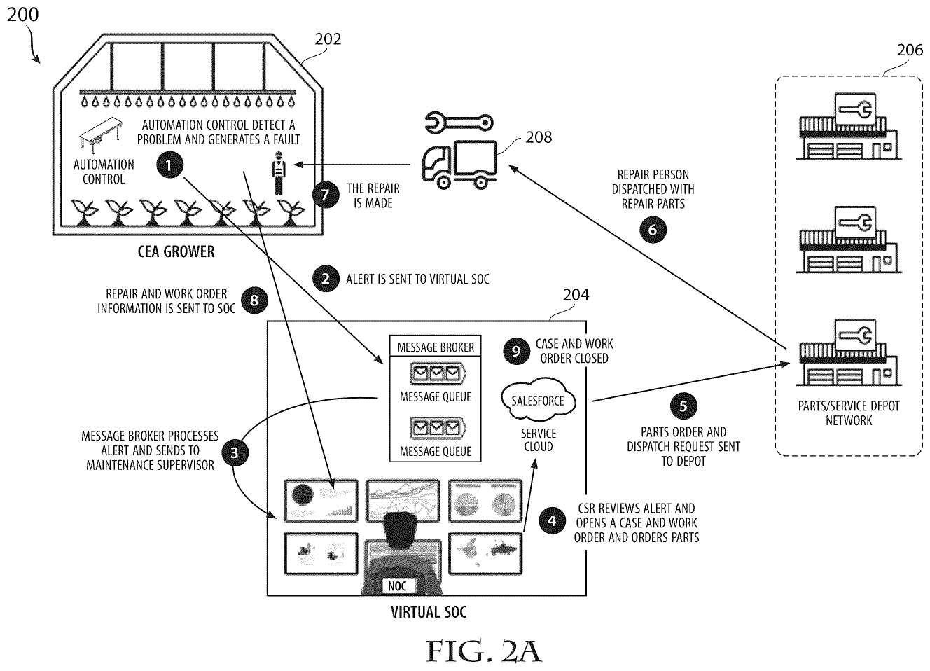

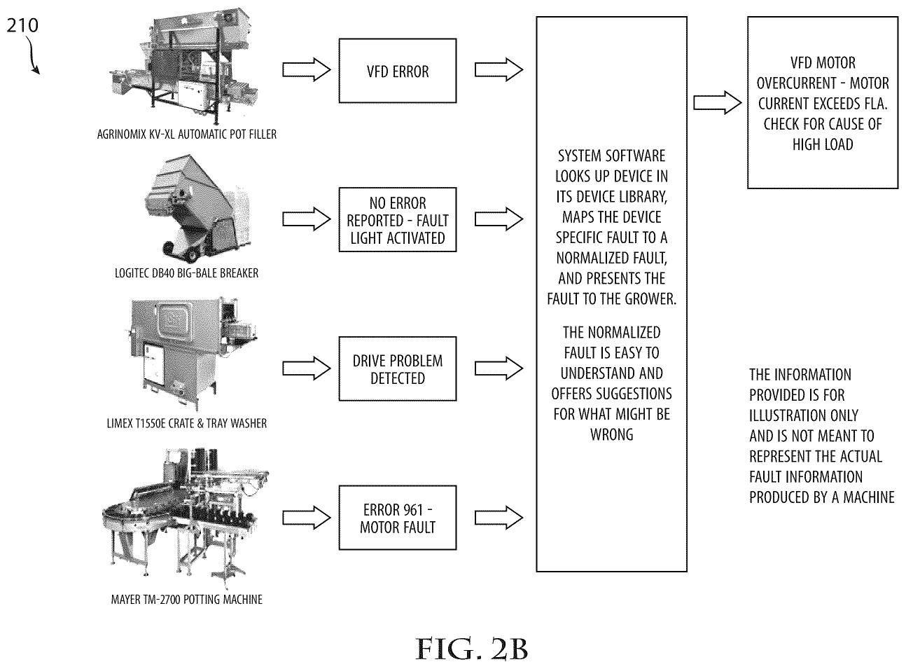

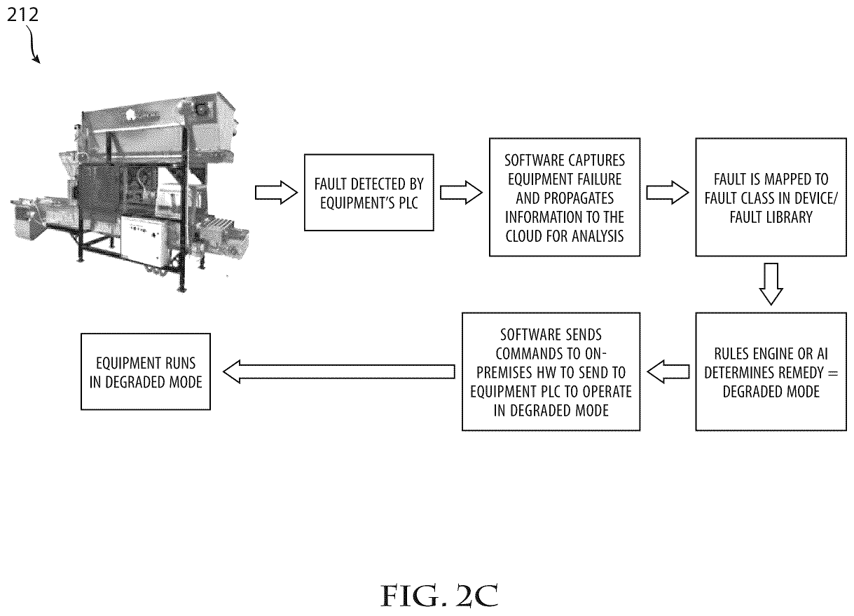

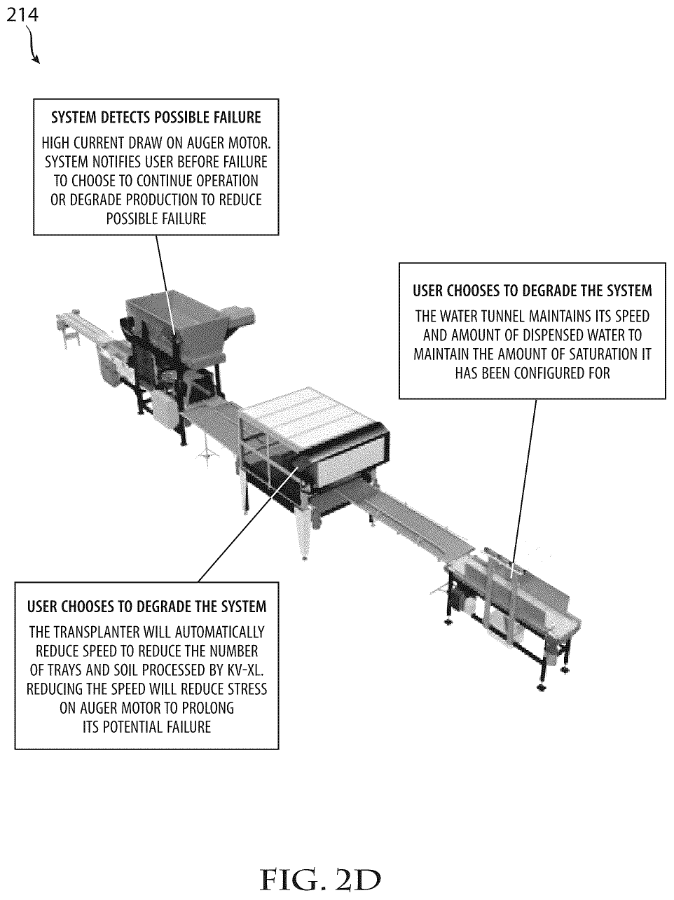

FIG. 2A illustrates a technician dispatch process flow 200. An example helps explain the workflow, transactions, and system support needed for an efficient and effective service organization. The example seems overly complicated, but only involves a couple of systems. First, a controller detects an alert. For example, a grower 202 can have an automated system that can detect a problem with whatever type of equipment is used at the grower 202 (which can, for example, be a greenhouse) and generate a fault. The error is captured, and a data payload is created by the device or the controller with alert/fault information. Alerts can be generated from machines, sensors, counters, cameras, and many types of IoT devices.

The alert is sent to a service center 204 that can include computer servers, algorithms, protocols, display screens, and other computer components. A person or system can review the alert and open a case and work orders or other orders. Alert propagation within the greenhouse or grower 202 can include a broker, an edge controller, and a gateway to provide security and a method of sending messages external to the greenhouse, as shown in FIG. 2A.

Software (such as a message broker) decodes the message and sends it to monitoring software to notify a CSR (customer service representative), who can review and open the case. This can be done on a visual map and in a report form. Filters can be used to restrict the level of alerts the CSR (or grower) wants to examine. Note that a grower 202 can call into the service center for service. The remainder of the workflow applies to both scenarios.

The CSR opens a case in a ticketing system unless the issue is trivial and quickly diagnosed on the phone. Optionally, the message broker can create a case programmatically and push it into the ticketing system. A priority is assigned, and the ticketing system starts a TAT (turnaround time) clock. In this scenario, the CSR (or a rules engine or AI software) diagnoses the issue and determines that a service technician is required. The CSR determines a service depot 206 that can handle the repair. The service depot 206 checks for parts availability in the service center's ERP (Enterprise Resource Planning) system, and if a shipment is needed, ships the parts to the depot or customer. If possible, the CSR checks for service aggregation to sweep the area with one truck trip. This is typically to perform preventative maintenance or to address minor alerts. The CSR builds a work order for the technician based on all the above to manage and track the process.

The service technician travels via a vehicle 208 to the greenhouse or grower 202. The service technician does the repair or maintenance operation. The service technician backflushes unused parts back to the service depot 206. The work order is updated, and the case is closed (assuming a successful repair). A mobile tool can capture repair information, parts used, track labor, and close the work order. Sometimes, a person can receive a notification or instructions via a browser, message, or application to perform the maintenance or repair themselves. For example, if the repair is relatively simple and can be performed with tools or parts that may already exist on-premises, a video or instructions for operating can be provided to a person's device, such as a mobile phone.

If external repair technicians are used, invoice reconciliation can be done utilizing the work order and the service center's ERP system. The disclosed system (i.e., any one or more of a computing system 500, an edge controller 116, a network server, a cloud-based server, a sensor, an IoT device, a gateway 114, and/or any component or machine disclosed herein) can aggregate disparate fault and preventative maintenance information from 3^{rd} party machines and present results, status, updates and so forth to a user in one place. The system can be configured to normalize fault/preventative maintenance information from disparate 3^{rd} party machines (i.e., made by different manufacturers) into a consistent information model. The system can intercept data transmitted from a PLC 128 to an HMI 126 to retrieve fault information from 3^{rd} party machines. The system can process fault data using rules engine and/or artificial intelligence to determine and suggest corrective action. The system can include auto-generation of a work list based on fault/preventative maintenance data collected and processed. The system can process input data to automatically generate governmental compliance reports. These principles above can be incorporated into any one or more components of a system, network, or device to enable a novel feature and achieve the practical solution disclosed herein.

FIG. 2B illustrates a harmonization approach to alert data 210, in accordance with the present disclosure. The point of this figure is to show how the harmonization of information across disparate machines can operate. A grower's equipment portfolio usually comprises many different machines sourced from multiple vendors. These equipment providers are small companies that provide a small part of a grower's overall needs. Each piece of equipment has its own operational characteristics and may be computer-controlled or relay-controlled. Each piece of equipment has its own set of fault characteristics, and the equipment will report whatever and however the equipment designers decide.

In the automotive industry, a standard, called the OBD II standard, was defined as a set of faults, a method to report the faults, and what to report. This allowed all automotive manufacturers the ability to provide diagnostic information consistently. It also allowed 3^{rd} parties to manufacture diagnostic readers and produce diagnostic software.

There is no equivalent standard in the CEA equipment industry. Manufacturers are left to decide what to report and how to report it, resulting in an inconsistent information model. The present disclosure provides a mechanism to present fault information consistently, regardless of what type of equipment is connected and the vendor that manufactures it. The disclosure provides a fault library that lists all possible faults. Each fault type has its own data structure used consistently across all equipment that reports that type of fault. If a fault is detected, the software captures the fault, maps in into the appropriate fault category and library, and fills in missing information. The approach allows all faults in a non-homogeneous set of equipment to report faults consistently. All faults are translated into human-readable sentences and provide troubleshooting tips. In some aspects, data in readable sentences or lists can provide detailed step-by-step repair instructions for a human or machine to follow.

As shown in FIG. 2B, a VFD error can relate to a variable frequency drive error, such as an overcurrent when the current exceeds the driver's rated capacity, which may be due to a short circuit, an overload on the motor, or a sudden spike in demand. Different types of machines are shown, such as an automatic pot filler, a big bale breaker, a crate and tray washer, and a potting machine. These are examples of the disparate types of machines in the CEA equipment industry, which is the context for the principles disclosed herein.

FIG. 2C illustrates a degradation approach to a series of equipment 212, in accordance with the present disclosure. When a machine faults but the fault is not catastrophic, it might be possible to run the machine at a slower speed or in another degraded mode. An example of this is when a motor has an overload failure caused by a binding gearbox. The machine can still operate by running the motor at a slower speed until the gear box is serviced. The machine can be put in degraded mode by issuing commands to the machine's PLC from the monitoring software. The system may instruct the grower to run the system in a degraded mode by reprogramming the PLC.

As shown in FIG. 2C, the fault can be detected by the PLC and the software captures the equipment failure and propagates information to the cloud for analysis. The fault can be mapped to a fault class in a device/fault library. A rules engine or AI model can determine a remedy. One example remedy may be to operate the line of equipment in a degraded mode. If so, the system sends commands to the on-premises hardware (one or more machines) to the equipment PLC to operate in the degraded mode. The machine then responds by operating in the degraded mode. The instructions may be for one piece of equipment or a series of disparate pieces of equipment, so that the degraded mode is consistent, for example, across a line of equipment.

AI models as used here can span a wide variety of types, each defined by how they learn, their internal architecture, the type of data they process, and the tasks they perform. One major axis of classification is by learning paradigm. In supervised learning, models are trained using labeled data where each input is paired with a known output. Common supervised models include linear and logistic regression, support vector machines, decision trees, random forests, and neural networks such as BERT or ResNet when applied in a supervised context. In contrast, unsupervised learning models are used to identify hidden structures in unlabeled data.

Clustering algorithms like K-means and DBSCAN, and dimensionality reduction techniques such as PCA, t-SNE, and autoencoders are typical examples. Bridging these two is semi-supervised learning, which combines a small amount of labeled data with a large volume of unlabeled data, often using teacher-student architectures or graph-based approaches. A distinct category is reinforcement learning (RL), where agents learn to make decisions through trial and error in an environment by receiving rewards. RL models include Q-learning, Deep Q Networks (DQN), and policy optimization methods like PPO and A3C.

Another important dimension of AI models is architecture. Classical symbolic AI, often called good old-fashioned AI (GOFAI), uses rule-based logic and expert systems. This contrasts with classical machine learning models, which rely more on statistical inference and include models like naive Bayes, k-nearest neighbors, and ensemble methods such as boosting and bagging. More recently, deep learning models, which employ multi-layer neural networks, have become dominant. These include feedforward neural networks for general tasks, convolutional neural networks (CNNs) for image data, recurrent neural networks (RNNs) for sequences like time-series or text, and transformer models, which underpin most modern advances in natural language processing and cross-modal AI. Transformer-based architectures such as BERT, GPT, and Vision Transformers (ViTs) use self-attention mechanisms to capture long-range dependencies and have become foundational in the field.

AI models can also be classified by the domain or modality of data they handle. In natural language processing (NLP), models like BERT, GPT, T5, and LLAMA perform tasks including language modeling, translation, summarization, and question answering. Some advanced models integrate retrieval mechanisms from external knowledge bases, such as Retrieval-Augmented Generation (RAG), to combine generative capabilities with factual grounding. In computer vision, models like ResNet, EfficientNet, YOLO, and RT-DETR are used for tasks such as image classification, object detection, and segmentation. For speech and audio, architectures like WaveNet, Whisper, and DeepSpeech handle speech recognition and synthesis. Multimodal models represent a frontier where models like CLIP, DALL.E, Gemini, and Flamingo combine and reason over multiple input types such as text, images, and audio.

Functionally, AI models are often divided into generative, discriminative, and retrieval-based categories. Generative models learn the data distribution and produce new samples, as seen in Generative Adversarial Networks (GANs), Variational Autoencoders (VAEs), and transformer-based language models like GPT. Discriminative models, on the other hand, focus on drawing boundaries between categories, as in logistic regression or SVMs, and are also the basis for fine-tuned BERT applications. Retrieval models identify relevant data from large corpora, using either traditional term-matching techniques like BM25 or modern dense vector search using models such as Dense Passage Retrieval (DPR) and FAISS.

In addition to these established categories, several emerging architectures are pushing the boundaries of AI capabilities. Graph Neural Networks (GNNs) allow models to learn over graph-structured data, capturing complex relational information. Diffusion models, like Stable Diffusion or Google's Imagen, are powerful generative models particularly adept at producing high-fidelity images. Neurosymbolic models blend neural learning with logical reasoning, providing hybrid approaches to tasks that require structured inference. Finally, foundation models represent a new class of extremely large, general-purpose models trained on massive datasets across multiple modalities. These include OpenAI's GPT-4, Meta's LLaMA, Google's Gemini, and Anthropic's Claude. Such models are pre-trained on diverse data and then fine-tuned or prompted for specific tasks, enabling a wide range of capabilities from a single core architecture.

Together, these various AI model types offer a rich toolbox for addressing problems across domains, from interpreting language and recognizing images to navigating physical environments and generating novel content. Any of these models may be applicable in the present disclosure.

The software knows the entire production facility and which machines make up the production lines in the facility. This is learned during a site audit before the software is deployed. Suppose the software has detected that a machine in the production line must run in a degraded mode. In that case, the rules engine or AI can determine the impact of this degradation across the production line and configure other machines in the production line to run in a mode consistent with the machine that must run in degraded mode. There can be a production line degraded mode, which impacts the overall production line or the whole production line, with one or more machines changing their operational mode according to the production line degraded mode.

For example, if an Agrinomix pot filler detects a fault, it is collected, analyzed, and determined to run in degraded mode, the rate at with trays/pots are filled may slow. In this case, if there is an Urbinati transplanter in the production line, and it is downstream from the Agrinomix tray filler, the software can configure the transplanter also to slow down to maintain synchronization in the production line.

Similarly, if the software detects a problem with a machine in a production line, and the software determines there is a way to reroute the production line to in some way bypass the affected machine, the software can issue a series of commands to reroute the production line to bypass the degraded or non-operational machine. In some cases, this may not occur in that the system may tell a grower that there is a fault in a specific production line or machine and the grower could choose to use another production line that have available to do the work.

In this regard, an aspect of this disclosure is to use a rules engine or an AI model to determine a course of action across an entire production line of disparate machines, based on detecting a problem with one of the machines in the production line. For each machine in the production line, determine what the correct degradation mode should be to maintain a constant (but degraded) production output. Issue a series of commands to all the equipment in the production line to achieve the new target, but with degraded production output.

The system can use the rules engine or an AI model to determine a course of action across an entire production line of disparate machines, based on the detecting a problem with one of the machines in the production line. Based on the configuration of the production line, issue a series of commands to the appropriate machines such that the degraded or non-operational machine is bypassed to achieve the new targeted, but potentially degraded production output.

As described above, by knowing the production facility and the state of each piece of equipment in the production facility, this disclosure outlines how the software facilitates communication between pieces of equipment that were never meant to communicate with each other.

Machines may perform different tasks, and each task may be adjusted based on the degraded mode of one of the machines. Thus, speed, volume, temperature, timing, input/output, fluid distribution, or other aspects of individual pieces of equipment can be adjusted based on the degradation of one piece of equipment in a line of equipment. FIG. 2D illustrates this approach.

FIG. 2D illustrates a degradation approach to a series of equipment 214, in accordance with the present disclosure. The production line shown includes from left to right a Martin Stolze Conveyor, an AgriNomix KV-XL Filler, and Urbinati RW14500 Transplanter and an AgriNomic Water Tunnel. The system detects a possible failure, such as a high current draw on an auger motor. The system notifies the user before the failure to choose to continue operation or degrade production to reduce the possibility of failure. The user can choose to degrade the system or an AI model may instruct the system to go into a degraded mode. The transplanter, for example, might automatically reduce speed to reduce the number of trays and soil processed by the KV-XL. Reducing the speed will reduce stress on the auger motor to prolong its potential failure. The user or AI model may choose to degrade the system in the sense that the water tunnel may maintain or reduce or increase its speed and amount of dispensed water to maintain or change the amount of saturation it has be configured to provide.

There are a number of features associated with the disclosed system. For example, the system can include a centralized alarm dashboard that aggregates alarms from all connected equipment into a single, unified dashboard. The system can include real-time monitoring and instant notification of critical events using multiple channels including email and SMS (short messaging system). Other features can include a connection to social media accounts or platforms for notifications or communications through such platforms. The system can store historical alarm data for trend analysis and reporting.

Another aspect of the system can include preventative maintenance analysis that can include operations such as automatically generating maintenance schedules based on equipment usage and condition. The system can integrate with existing maintenance management systems and provide detailed maintenance reports and logs. The system can track maintenance activities and outcomes for continuous improvement.

In another aspect, the system can include production performance metrics which can include the system being configured to track key performance indicators (KPIs) such as throughput, cycle time, and downtime. The system in this respect can provide real-time visibility into production processes. The system can take such data and generate graphical representations through different color schemes or graphical objects to represent the tracked data. The system can also analyze production data to identify bottlenecks and inefficiencies. Again, the data for the system can be drawn from disparate types of machines from different companies and the ability to capture the data (such as data from a PLC that is transmitted or communicated to an HMI on the machine) in ways that the respective machine was not designed to enable can be part of this disclosure to enable the system to perform the tracking and maintenance procedures disclosed above.

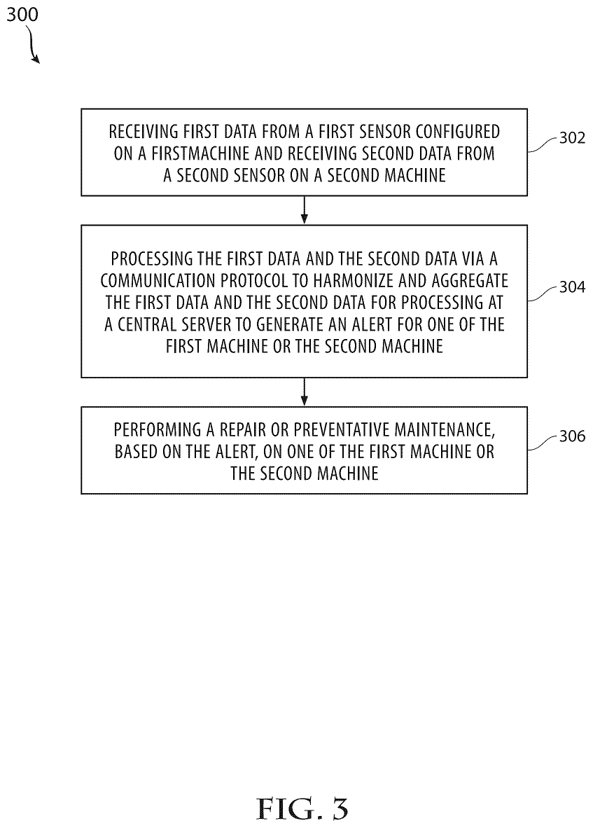

FIG. 3 illustrates an example process 300 for managing a variety of machines. This method is from the standpoint of a machine, such as an agricultural machine. The process 300 can include receiving first data from a first sensor or a first programmable logic controller configured on a first machine and receiving second data from a second sensor or a second programmable logic controller on a second machine (302). The first machine and the second machine can be configured to generate fault data or diagnostic data and the first sensor and the second sensor can be added to the machine to enable receipt of the fault data or diagnostic data and transmission of the fault data or diagnostic data to a central server. The first machine and the second machine can be different types of machines with different protocols for faults and diagnostic data, and can be made by different manufacturers.

The process 300 can include processing the first data and the second data via a communication protocol to harmonize and aggregate the first data and the second data for processing at a central server to generate an alert for one of the first machine or the second machine (304). For example, harmonizing the data can include collecting data from disparate systems and making the data appear consistent. A safety stop alert can be reported from disparate machines in different ways with different names, signals, or protocols. The system can call differently configured signals a safety stop alert no matter how equipment reports it.

The process 300 can include performing a repair or preventative maintenance, based on the alert, on one of the first machine or the second machine, or providing notice to a human to take certain remedial steps (306). The notice can be a text, an email, a voicemail, a notification through an application, or any kind of communication. In some aspects, the first machine and the second machine are on-premises and at the premises can include a programmable logic controller (PLC) configured on the first machine or the second machine and the premises can include an edge computer that uses any one or more of a number of protocols for gathering the data. The alert can be passed from the edge computer to a cloud-based server. In some aspects, process 300 may include providing a notice to a human for performing certain steps to remedy the problem.

In some aspects, one of the first data or the second data can be intercepted from a communication, configured as designed on the first machine or the second machine, from a data source such as, for example, a programmable logic controller to a human-machine interface. Other ways to detect faults such as sensors or other detectors can be used as well. The method 300 can further run in the degraded mode based on the alert and can reconfigure a whole production line including disparate equipment to run in the degraded mode. The first data can be received via a communication protocol selected from Message Queues Telemetry Transport (MQTT), Modbus Transmission Control Protocol/Internet Protocol (TCP/IP), Object Linking and Embedding Process Control Unified Architecture (OPC UA), or other communications protocol. Any communication protocol may be used.

In some aspects, the repair or preventive maintenance is initiated by dispatching a service technician based on the alert. When operating in a degraded mode, the degraded mode can involve reducing a speed or output of a machine to prevent potential failure. The alert can be generated by harmonizing and aggregating data from a single sensor or multiple sensors to detect a fault. The apparatus can use an artificial intelligence model to determine an appropriate degraded mode for each machine in a production line.

This disclosure can include a system configured to perform the operations disclosed herein. The system can be configured on a premises of a grower and/or can include a central server or a cloud-based server that aggregates and processes data to aid in maintenance and repair operations. One aspect may include a computer-readable storage medium storing instructions which, when executed by a processor, cause the processor to be configured to perform any one or more operation disclosed herein.

In some aspects, the method 300 may include a method of handling alerts from a plurality of disparate systems, the method including: receiving first data from a first sensor or a first programmed logic controller configured on a first machine and receiving second data from a second sensor or a second programmed logic controller on a second machine, wherein the first machine and the second machine are different types of machines; processing the first data and the second data via a communication protocol to harmonize and aggregate the first data and the second data at a central server to generate an alert for one of the first machine or the second machine; and performing a repair, preventative maintenance, or run in a degraded mode, based on the alert, on one of the first machine or the second machine or providing a notice regarding steps to be taken by a human.

In some aspects, a computer-readable storage medium stores instructions which, when executed by at least one processor coupled to the computer-readable storage medium cause the at least one processor to be configured to: receive first data from a first sensor or a first programmed logic controller configured on a first machine and receiving second data from a second sensor or a second programmed logic controller on a second machine, wherein the first machine and the second machine are different types of machines; process the first data and the second data via a communication protocol to harmonize and aggregate the first data and the second data at a central server to generate an alert for one of the first machine or the second machine; and perform a repair, preventative maintenance, or run in a degraded mode, based on the alert, on one of the first machine or the second machine or provide a notice regarding steps to be taken by a human.

In some aspects, an apparatus can include: at least one memory; and at least one processor coupled to the at least one memory and configured to: capture, on a machine and via a device, data indicative of an alert or error; generate, based on the data indicative of the alert of the error, a data payload on-premises via one or more of the machine, a broker, an edge controller and a gateway; and transmit the data payload to an external server to enable a case to be opened and a service technician to be dispatched to repair or service the machine.

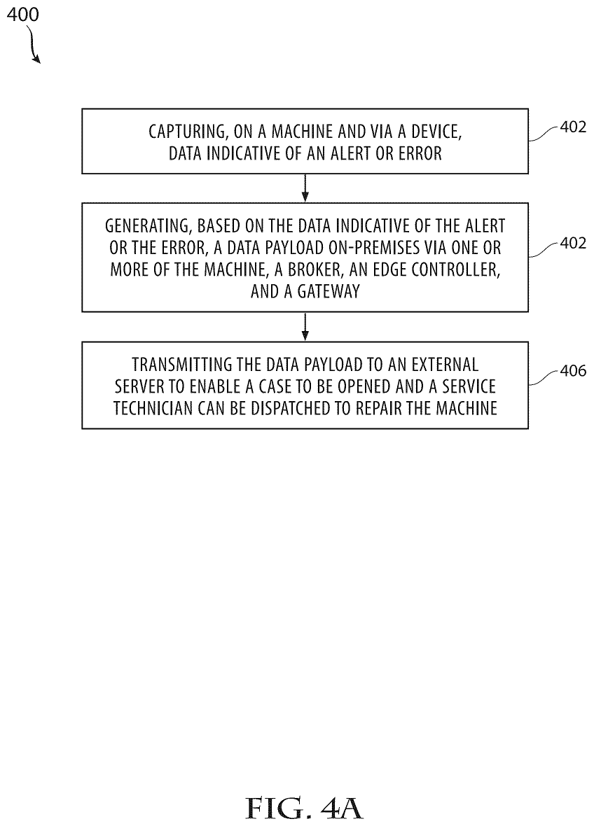

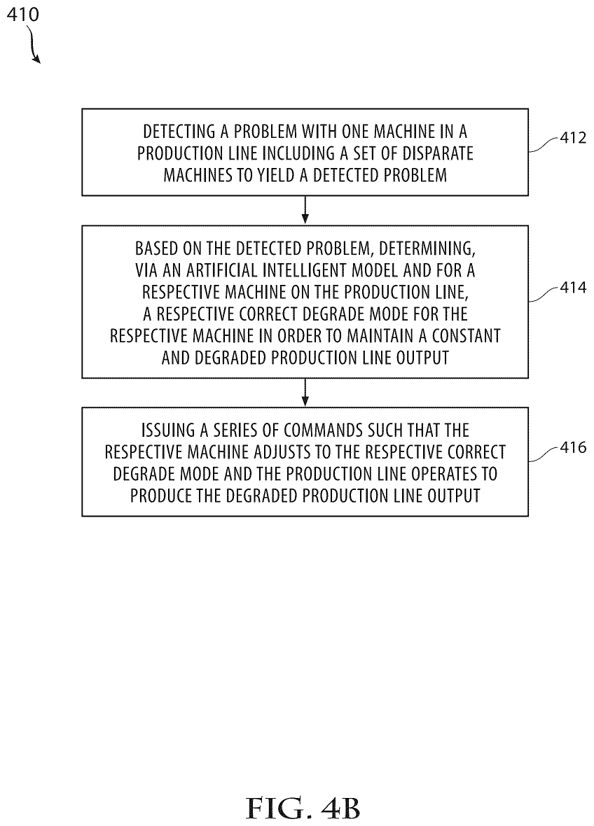

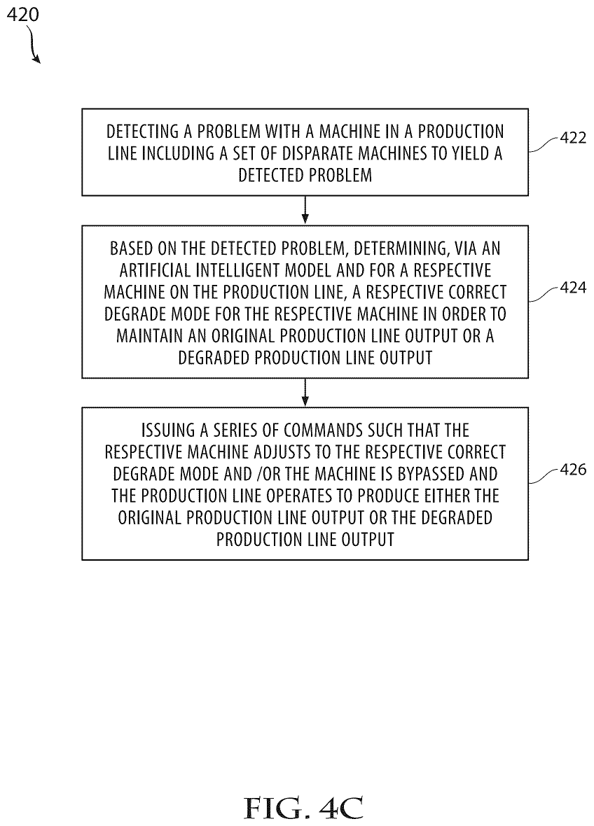

FIG. 4A illustrates a process 400 from the standpoint of a machine or on-premises set of equipment configured to enable communication with a server with respect to faults, alerts or diagnostic data. The process 400 can include capturing, on a machine and via a device, data indicative of an alert or error (402). The device can be a sensor, a counter, a camera, a component of an IoT device, an IoT device, a heat sensor, a sound sensor, and so forth. The machine can be a greenhouse machine such as a pot dispenser, water tunnel, tray filler, conveyer belt, lighting system or watering system, a farm machine such as a tractor, and so forth.

The process 400 can include generating, based on the data indicative of the alert or the error, a data payload on-premises via one or more of the machine, a broker, an edge controller, and a gateway (404). The process 400 can include transmitting the data payload to an external server to enable a case to be opened and a service technician can be dispatched to repair or maintain the machine (406). In some aspects, a case may or may not be opened, but regardless, an alert is propagated. The service technician may obtain parts from a service center and the external server may aggregate service calls for the service technician for efficiency.

The on-premises system can include such components as sensors, PLCs, communication protocols, an edge controller and a gateway to gather data from disparate machines configured where necessary with sensors to obtain the alter or error or fault data and enable a data payload to be generated and transmitted to an external server or cloud server in a cloud computing environment 102. The on-premises system can include a flexible architecture as well and is not limited to the components described above.

This disclosure can include systems that cover one or more of the machine (a greenhouse machine, such as a sprinkler system or conveyor belt, or a farm machine, such as a tractor), sensors, interfaces, VPN appliances, communication protocol layers, edge controllers for data management, a gateway, and so forth.

FIG. 4B illustrates a method 410 related to issuing a series of commands to a production line. The method 410 includes detecting a problem with one machine in a production line comprising a set of disparate machines to yield a detected problem (412); based on the detected problem, determine, via an artificial intelligence model or rule chain and for a respective machine on the production line, a respective correct degraded mode for the respective machine to maintain a constant and a degraded production line output (414); and issuing a series of commands such that the respective machine adjusts to the respective correct degraded mode and the production line operates to produce the degraded production line output (416).

In some aspects, a system can include a production line comprising a set of disparate machines; a processor; and a computer-readable storage device storing instructions which, when executed by the processor, cause the processor to be configured to: detect a problem with one machine in the production line to yield a detected problem; based on the detected problem, determine, via an artificial intelligence model or rule chain and for a respective machine on the production line, a respective correct degraded mode for the respective machine to maintain a constant and a degraded production line output; and issue a series of commands such that the respective machine adjusts to the respective correct degraded mode and the production line operates to produce the degraded production line output.

In some aspects, the method can include intercepting data from a data source comprising one or more of a sensor, a device or a communication between a programmable logic controller, a sensor or other component, and a human-machine interface to enhance fault detection capabilities.

An alert can be generated by harmonizing and aggregating data from a single sensor or multiple sensors to detect a fault, thereby improving an accuracy of fault detection. The method can further include using an artificial intelligence model to determine an appropriate degraded mode for each machine in a production line, ensuring consistent operation across disparate equipment. A repair or preventative maintenance can be initiated by dispatching a service technician based on an alert, thereby reducing downtime and improving efficiency. The respective correct degraded mode can involve reducing a speed or output of a machine to prevent potential failure, thereby extending an operational life of equipment. The method can also include reconfiguring a whole production line comprising disparate equipment to run in the respective correct degraded mode, ensuring minimal disruption to production output.

The data can be intercepted via a communication protocol selected from Message Queues Telemetry Transport (MQTT), Modbus Transmission Control Protocol/Internet Protocol (TCP/IP), Object Linking and Embedding Process Control Unified Architecture (OPC UA), or other communications protocol.

In some aspects, the method can include generating a data payload on-premises via one or more of a machine, a broker, an edge controller, and a gateway, and transmitting the data payload to an external server to enable a case to be opened and a service technician to be dispatched. The method can further include capturing, on a machine and via a device, data indicative of an alert or error, and generating, based on the data indicative of the alert or the error, a data payload on-premises.

In another aspect, a system can include: a production line having a set of disparate machines; a processor; and a computer-readable storage device storing instructions which, when executed by the processor, cause the processor to be configured to: detect a problem with one machine in the production line to yield a detected problem; based on the detected problem, determine, via an artificial intelligence model or rule chain and for a respective machine on the production line, a respective correct degraded mode for the respective machine in order to maintain a constant and a degraded production line output; and issue a series of commands such that the respective machine adjusts to the respective correct degraded mode and the production line operates to produce the degraded production line output.

FIG. 4C illustrates a method 420 related to using an AI model. The method 420 can include detecting a problem with a machine in a production line comprising a set of disparate machines to yield a detected problem (422). The method can include, based on the detected problem, determining, via an artificial intelligence model or rule chain, and for a respective machine on the production line, a respective correct degradation mode for the respective machine in order to maintain an original production line output or a degraded production line output (424). The method can further include issuing a series of commands such that the respective machine adjusts to the respective correct degraded mode or the respective machine is bypassed, and the production line operates to produce either the original production line output or the degraded production line output (426).

In some aspects, a system can include a production line comprising a set of disparate machines; a processor; and a computer-readable storage device storing instructions which, when executed by the processor, cause the processor to be configured to: detect a problem with one machine in the production line to yield a detected problem; based on the detected problem, determine, via an artificial intelligence model or rule chain and for a respective machine on the production line, a respective correct degraded mode for the respective machine in order to maintain an original production line output or a degraded production line output; and issue a series of commands such that the respective machine adjusts to the respective correct degraded mode or the respective machine is bypassed and the production line operates to produce either the original production line output or the degraded production line output.

A rule chain can be a sequence or network of “if-then” rules that are applied in order or in combination to process information, make decisions and infer conclusions. It can be a linked series of logical rules where the output or conclusion of one rule may become the input or condition for the next. The approach enables a system to perform multi-step reasoning or decision-making.

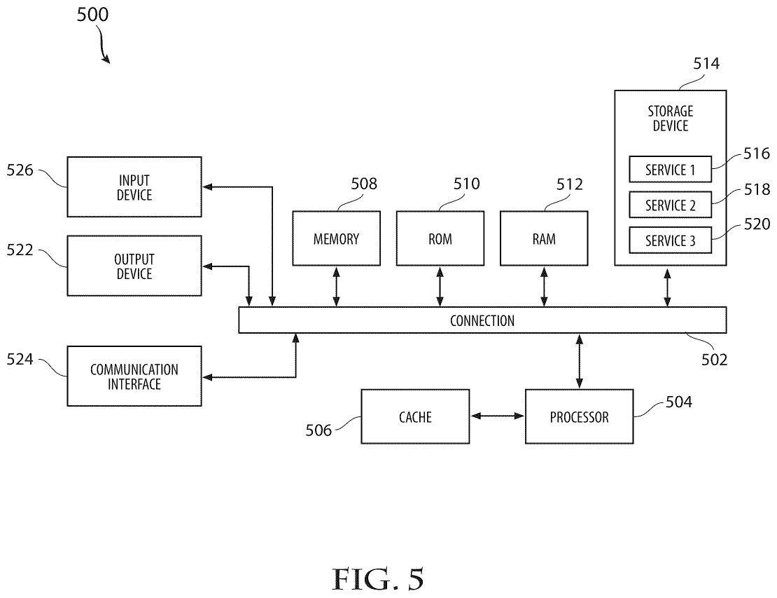

FIG. 5 is a diagram illustrating an example of a system for implementing certain aspects of the present technology. In particular, FIG. 5 illustrates an example of computing system 500, which can be for example any computing device making up internal computing system, a remote computing system, a camera, a depth map or multiple depth maps, or any component thereof in which the components of the system are in communication with each other using connection 502. Connection 502 can be a physical connection using a bus, or a direct connection into processor 504, such as in a chipset architecture. Connection 502 can also be a virtual connection, networked connection, or logical connection.

In some aspects, computing system 500 is a distributed system in which the functions described in this disclosure can be distributed within a datacenter, multiple data centers, a peer network, etc. In some aspects, one or more of the described system components represents many such components, each performing some or all of the functions for which the component is described. In some aspects, the components can be physical or virtual devices.

Example computing system 500 includes at least one processing unit (CPU or processor 504) and connection 502 that couples various system components including memory 508, such as read-only memory (ROM) such as ROM 510 and random-access memory 512 (RAM) to processor 504. Computing system 500 can include a cache 506 of high-speed memory connected directly with, in close proximity to, or integrated as part of processor 504.

Processor 504 can include any general-purpose processor and a hardware service or software service, such as services such as a first service 516, a second service 518, and a third service 520 stored in storage device 514, configured to control processor 504 as well as a special- purpose processor where software instructions are incorporated into the actual processor design. Processor 504 may essentially be a completely self-contained computing system, containing multiple cores or processors, a bus, memory controller, cache, etc. A multi-core processor may be symmetric or asymmetric.

To enable user interaction, computing system 500 includes a communications interface 524, which can represent any number of input mechanisms, such as a microphone for speech, a touch-sensitive screen for gesture or graphical input, keyboard, mouse, motion input, speech, etc. Computing system 500 can also include output device 522, which can be one or more of a number of output mechanisms. In some instances, multimodal systems can enable a user to provide multiple types of input/output to communicate with computing system 500. Computing system 500 can include communications interface 524, which can generally govern and manage the user input and system output.

The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, WLAN signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/long term evolution (LTE) cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 524 may also include one or more GNSS receivers or transceivers that are used to determine a location of the computing system 500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 514 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a Europay, Mastercard and Visa (EMV) chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 514 can include software services, servers, services, etc., that when the code that defines such software is executed by the processor 504, it causes the system to perform a function. In some aspects, a hardware service that performs a particular function can include the software component stored in a computer-readable medium in connection with the necessary hardware components, such as processor 504, connection 502, output device 522, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, an engine, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to thoroughly understand the aspects and examples provided herein. However, it will be understood by one of ordinary skill in the art that the aspects may be practiced without these specific details. For clarity of explanation, in some instances, the present technology may be presented as including individual functional blocks, including devices, device components, steps, or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data that cause or otherwise configure a general-purpose computer, special-purpose computer, or a processing device to perform a certain function or group of functions. Portions of computer resources used can be accessed over a network. The computer executable instructions may be, for example, binaries, intermediate format instructions such as assembly language, firmware, or source code. Examples of computer-readable media that may be used to store instructions, information used, and/or information created during methods according to the described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof. They can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smartphones, mobile phones, tablet devices, or other small form factor personal computers, personal digital assistants, rackmount devices, standalone devices, and so on. Functionality described herein also can be embodied in peripherals or add-in cards. Such functionality can also be implemented on a circuit board among different chips or processes executing in a single device.

The instructions, media for conveying such instructions, computing resources for executing them, and other structures for supporting such computing resources are examples of means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

The various illustrative logical blocks, modules, engines, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules, engines, or components may be implemented together in an integrated logic device or separately as discrete but interoperable logic devices. If implemented in software, then the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include: The following provides an overview of some claim Clauses of the present disclosure:

### CLAUSE SET I (PERFORMING A REPAIR OR PREVENTIVE MAINTENANCE OR RUN IN A DEGRADED MODE)

Clause 1. An apparatus comprising: at least one memory; and at least one processor coupled to the at least one memory and configured to: receive first data from a first sensor or first programmed logic controller configured on a first machine and receive second data from a second sensor or a second programmed logic controller on a second machine; process the first data and the second data via a communication protocol to harmonize and aggregate the first data and the second data at a central server to generate an alert for one of the first machine or the second machine; and perform a repair, preventative maintenance, or run in a degraded mode based on the alert, on one of the first machine or the second machine or provide a notice regarding steps to be taken by a human.
Clause 2. The apparatus of clause 1, wherein one of the first data or the second data is intercepted from a communication, configured as designed on the first machine or the second machine, from a data source such as, for example, a programmable logic controller to a human-machine interface.
Clause 3. The apparatus of clause 1 or any previous clause, wherein when the at least one processor coupled to the at least one memory is configured to run in the degraded mode based on the alert, the apparatus reconfigures a whole production line comprising disparate equipment to run in the degraded mode.
Clause 4. The apparatus of clause 1 or any previous clause, wherein the first data is received via a communication protocol selected from Message Queues Telemetry Transport (MQTT), Modbus Transmission Control Protocol/Internet Protocol (TCP/IP), Object Linking and Embedding Process Control Unified Architecture (OPC UA), or other communications protocol.
Clause 5. The apparatus of clause 1 or any previous clause, wherein the repair or preventive maintenance is initiated by dispatching a service technician based on the alert.
Clause 6. The apparatus of clause 1 or any previous clause, wherein the degraded mode involves reducing a speed or output of a machine to prevent potential failure.
Clause 7. The apparatus of clause 1 or any previous clause, wherein the alert is generated by harmonizing and aggregating data from a single sensor or multiple sensors to detect a fault.
Clause 8. The apparatus of clause 1 or any previous clause, wherein the apparatus uses an artificial intelligence model to determine an appropriate degraded mode for each machine in a production line.
Clause 9. A method of handling alerts from a plurality of disparate systems, the method comprising: receiving first data from a first sensor or a first programmed logic controller configured on a first machine and receiving second data from a second sensor or a second programmed logic controller on a second machine, wherein the first machine and the second machine are different types of machines; processing the first data and the second data via a communication protocol to harmonize and aggregate the first data and the second data at a central server to generate an alert for one of the first machine or the second machine; and performing a repair, preventative maintenance, or run in a degraded mode, based on the alert, on one of the first machine or the second machine or provide a notice regarding steps to be taken by a human.
Clause 10. The method of clause 9, wherein one of the first data or the second data is intercepted from a communication, configured as designed on the first machine or the second machine, from a data source such as, for example, a programmable logic controller to a human-machine interface.
Clause 11. The method of clause 9 or any previous clause, further comprising: in the degraded mode based on the alert, reconfiguring a whole production line comprising disparate equipment to run in the degraded mode.
Clause 12. The method of clause 9 or any previous clause, wherein the first data is received via a communication protocol selected from Message Queues Telemetry Transport (MQTT), Modbus Transmission Control Protocol/Internet Protocol (TCP/IP), Object Linking and Embedding Process Control Unified Architecture (OPC UA), or other communications protocol.
Clause 13. The method of clause 9 or any previous clause, wherein the repair or preventive maintenance is initiated by dispatching a service technician based on the alert.
Clause 14. The method of clause 9 or any previous clause, wherein the degraded mode involves reducing a speed or output of a machine to prevent potential failure.
Clause 15. The method of clause 9 or any previous clause, wherein the alert is generated by harmonizing and aggregating data from a single sensor or multiple sensors to detect a fault.
Clause 16. The method of clause 9 or any previous clause, wherein the method uses an artificial intelligence model to determine an appropriate degraded mode for each machine in a production line.
Clause 17. A computer-readable storage medium storing instructions which, when executed by at least one processor coupled to the computer-readable storage medium cause the at least one processor to be configured to: receive first data from a first sensor or a first programmed logic controller configured on a first machine and receiving second data from a second sensor or a second programmed logic controller on a second machine, wherein the first machine and the second machine are different types of machines; process the first data and the second data via a communication protocol to harmonize and aggregate the first data and the second data at a central server to generate an alert for one of the first machine or the second machine; and perform a repair, preventative maintenance, or run in a degraded mode, based on the alert, on one of the first machine or the second machine or provide a notice regarding steps to be taken by a human.
Clause 18. The computer-readable storage medium of clause 17, wherein one of the first data or the second data is intercepted from a communication, configured as designed on the first machine or the second machine, from a data source such as, for example, a programmable logic controller to a human-machine interface.
Clause 19. The computer-readable storage medium of clause 17 or any previous clause, wherein, when running in the degraded mode, based on the alert, the at least one processor is configured to: reconfigure a whole production line comprising disparate equipment to run in the degraded mode.
Clause 20. The computer-readable storage medium of clause 17 or any previous clause, wherein the first data is received via a communication protocol selected from Message Queues Telemetry Transport (MQTT), Modbus Transmission Control Protocol/Internet Protocol (TCP/IP), Object Linking and Embedding Process Control Unified Architecture (OPC UA), or other communications protocol.
Clause 21. An apparatus comprising: at least one memory; and at least one processor coupled to the at least one memory and configured to: capture, on a machine and via a device, data indicative of an alert or error; generate, based on the data indicative of the alert of the error, a data payload on-premises via one or more of the machine, a broker, an edge controller and a gateway; and transmit the data payload to an external server to enable a case to be opened and a service technician to be dispatched to repair or service the machine.
Clause 22. A method comprising: capturing, on a machine and via a device, data indicative of an alert or error; generating, based on the data indicative of the alert of the error, a data payload on-premises via one or more of the machine, a broker, an edge controller and a gateway; and transmitting the data payload to an external server to enable a case to be opened and a service technician to be dispatched to repair or service the machine.
Clause 23. A computer-readable storage medium storing instructions which, when executed by at least one processor coupled to the computer-readable storage medium cause the at least one processor to be configured to: capture, on a machine and via a device, data indicative of an alert or error; generate, based on the data indicative of the alert of the error, a data payload on-premises via one or more of the machine, a broker, an edge controller and a gateway; and transmit the data payload to an external server to enable a case to be opened and a service technician to be dispatched to repair or service the machine.

### CLAUSE SET II (OPERATING A PRODUCTION LINE IN A DEGRADED MODE)

Clause 1. A method comprising: detecting a problem with one machine in a production line comprising a set of disparate machines to yield a detected problem; based on the detected problem, determine, via an artificial intelligence model or rule chain and for a respective machine on the production line, a respective correct degraded mode for the respective machine in order to maintain a constant and a degraded production line output; and issuing a series of commands such that a respective machine adjusts to the respective correct degraded mode and the production line operates to produce the degraded production line output.
Clause 2. The method of clause 1, further comprising: intercepting data from a data source comprising one or more of a sensor, a device or a communication between a programmable logic controller, a sensor or other component, and a human-machine interface to enhance fault detection capabilities.
Clause 3. The method of clause 1 or any previous clause, wherein an alert is generated by harmonizing and aggregating data from a single sensor or multiple sensors to detect a fault, thereby improving an accuracy of fault detection.
Clause 4. The method of clause 1 or any previous clause, further comprising using an artificial intelligence model to determine an appropriate degraded mode for each machine in a production line, ensuring consistent operation across disparate equipment.
Clause 5. The method of clause 1 or any previous clause, wherein a repair or preventative maintenance is initiated by dispatching a service technician based on an alert, thereby reducing downtime and improving efficiency.
Clause 6. The method of clause 1 or any previous clause, wherein the respective correct degraded mode involves reducing a speed or output of a machine to prevent potential failure, thereby extending an operational life of equipment.
Clause 7. The method of clause 1 or any previous clause, further comprising reconfiguring a whole production line comprising disparate equipment to run in the respective correct degraded mode, ensuring minimal disruption to production output.
Clause 8. The method of clause 2 or any previous clause, wherein the data is intercepted via a communication protocol selected from Message Queues Telemetry Transport (MQTT), Modbus Transmission Control Protocol/Internet Protocol (TCP/IP), Object Linking and Embedding Process Control Unified Architecture (OPC UA), or other communications protocol.
Clause 9. The method of clause 1 or any previous clause, further comprising generating a data payload on-premises via one or more of a machine, a broker, an edge controller, and a gateway, and transmitting the data payload to an external server to enable a case to be opened and a service technician to be dispatched.
Clause 10. The method of clause 1 or any previous clause, further comprising capturing, on a machine and via a device, data indicative of an alert or error, and generating, based on the data indicative of the alert or the error, a data payload on-premises.
Clause 11. A system comprising: a production line comprising a set of disparate machines; a processor; and a computer-readable storage device storing instructions which, when executed by the processor, cause the processor to be configured to: detect a problem with one machine in the production line to yield a detected problem; based on the detected problem, determine, via an artificial intelligence model or rule chain and for a respective machine on the production line, a respective correct degraded mode for the respective machine in order to maintain a constant and a degraded production line output; and issue a series of commands such that the respective machine adjusts to the respective correct degraded mode and the production line operates to produce the degraded production line output.
Clause 12. The system of clause 11, further comprising a communication protocol to intercept data from a data source comprising one or more of a sensor, a device or a programmable logic controller to a human-machine interface, enhancing fault detection capabilities.
Clause 13. The system of clause 11, wherein an alert is generated by harmonizing and aggregating data from a single sensor or multiple sensors to detect a fault, thereby improving an accuracy of fault detection.
Clause 14. The system of clause 11 or any previous clause, further comprising an artificial intelligence model to determine an appropriate degraded mode for each machine in a production line, ensuring consistent operation across disparate equipment.
Clause 15. The system of clause 11 or any previous clause, wherein a repair or preventative maintenance is initiated by dispatching a service technician based on an alert, thereby reducing downtime and improving efficiency.
Clause 16. The system of clause 11 or any previous clause, wherein the respective correct degraded mode involves reducing a speed or output of a machine to prevent potential failure, thereby extending an operational life of equipment.
Clause 17. The system of clause 11 or any previous clause, further comprising reconfiguring a whole production line comprising disparate equipment to run in the respective correct degraded mode, ensuring minimal disruption to production output.
Clause 18. The system of clause 12 or any previous clause, wherein the data is intercepted via a communication protocol selected from Message Queues Telemetry Transport (MQTT), Modbus Transmission Control Protocol/Internet Protocol (TCP/IP), Object Linking and Embedding Process Control Unified Architecture (OPC UA), or other communications protocol.
Clause 19. The system of clause 11 or any previous clause, further comprising generating a data payload on-premises via one or more of a machine, a broker, an edge controller, and a gateway, and transmitting the data payload to an external server to enable a case to be opened and a service technician to be dispatched.
Clause 20. The system of clause 11 or any previous clause, further comprising capturing, on a machine and via a device, data indicative of an alert or error, and generating, based on the data indicative of the alert or the error, a data payload on-premises.
Clause 21. A computer-readable storage medium storing instructions which, when executed by at least one processor, cause the at least one processor to be configured to: detect a problem with one machine in a production line to yield a detected problem; based on the detected problem, determine, via an artificial intelligence model or rule chain and for a respective machine on the production line, a respective correct degraded mode for the respective machine in order to maintain a constant and a degraded production line output; and issue a series of commands such that the respective machine adjusts to the respective correct degraded mode and the production line operates to produce the degraded production line output.
Clause 22. The computer-readable storage medium of clause 21, wherein an alert is generated by harmonizing and aggregating data from a single sensor or multiple sensors to detect a fault, thereby improving an accuracy of fault detection.
Clause 23. The computer-readable storage medium of clause 21 or any previous clause, further comprising instructions to use an artificial intelligence model to determine an appropriate degraded mode for each machine in a production line, ensuring consistent operation across disparate equipment.
Clause 24. The computer-readable storage medium of clause 21 or any previous clause, wherein a repair or preventative maintenance is initiated by dispatching a service technician based on an alert, thereby reducing downtime and improving efficiency.
Clause 25. The computer-readable storage medium of clause 21 or any previous clause, wherein the respective correct degraded mode involves reducing a speed or output of a machine to prevent potential failure, thereby extending an operational life of equipment.
Clause 26. The computer-readable storage medium of clause 21 or any previous clause, further comprising instructions to reconfigure a whole production line comprising disparate equipment to run in the respective correct degraded mode, ensuring minimal disruption to production output.
Clause 27. The computer-readable storage medium of clause 22 or any previous clause, wherein the data is intercepted via a communication protocol selected from Message Queues Telemetry Transport (MQTT), Modbus Transmission Control Protocol/Internet Protocol (TCP/IP), Object Linking and Embedding Process Control Unified Architecture (OPC UA), or other communications protocol.
Clause 28. The computer-readable storage medium of clause 21 or any previous clause, further comprising instructions to generate a data payload on-premises via one or more of a machine, a broker, an edge controller, and a gateway, and transmit the data payload to an external server to enable a case to be opened and a service technician to be dispatched.
Clause 29. The computer-readable storage medium of clause 21 or any previous clause, further comprising instructions to capture, on a machine and via a device, data indicative of an alert or error, and generate, based on the data indicative of the alert or the error, a data payload on-premises.
Clause 30. The computer-readable storage medium of clause 21 or any previous clause, further comprising instructions to perform a repair or preventative maintenance, based on an alert, on one of a first machine or a second machine.

### CLAUSE SET III (USING AN AI MODEL TO DETERMINE WHICH MACHINE TO PUT IN A DEGRADED MODE ON A PRODUCTION LINE)

Clause 1. A method comprising: detecting a problem with a machine in a production line comprising a set of disparate machines to yield a detected problem; based on the detected problem, determining, via an artificial intelligence model or rule chain and for a respective machine on the production line, a respective correct degraded mode for the respective machine in order to maintain an original production line output or a degraded production line output; and issuing a series of commands such that the respective machine adjusts to the respective correct degraded mode or the respective machine is bypassed and the production line operates to produce either the original production line output or the degraded production line output.
Clause 2. The method of clause 1, further comprising intercepting data from a data source comprising one or more of a sensor, a device or a communication between a programmable logic controller (PLC), and a human-machine interface (HMI) to enhance fault detection capabilities.
Clause 3. The method of clause 1 or any previous clause, wherein generating alerts comprises harmonizing and aggregating data from a single sensor or multiple sensors to improve fault detection accuracy.
Clause 4. The method of clause 1 or any previous clause, further comprising using an artificial intelligence model to determine an appropriate degraded mode for each machine in a production line, ensuring consistent operation across disparate equipment.
Clause 5. The method of clause 1 or any previous clause, further comprising initiating repair or preventative maintenance by dispatching a service technician based on an alert, thereby reducing downtime and improving efficiency.
Clause 6. The method of clause 1 or any previous clause, wherein the respective correct degraded mode involves reducing a speed or output of a machine to prevent potential failure, thereby extending an operational life of equipment.
Clause 7. The method of clause 1 or any previous clause, further comprising reconfiguring a whole production line comprising disparate equipment to run in a production line degraded mode, ensuring minimal disruption to production output.
Clause 8. The method of clause 1 or any previous clause, wherein receiving data comprises using communication protocols such as Message Queues Telemetry Transport (MQTT), Modbus Transmission Control Protocol/Internet Protocol (TCP/IP), Object Linking and Embedding Process Control Unified Architecture (OPC UA), or other communications protocol.
Clause 9. The method of clause 1, further comprising generating a data payload on-premises via one or more of the machine, a broker, an edge controller, and a gateway, and transmitting the data payload to an external server to enable a case to be opened and a service technician to be dispatched.
Clause 10. The method of clause 1 or any previous clause, further comprising capturing data indicative of an alert or error on a machine and generating a data payload on-premises based on this data.
Clause 11. A system comprising: a production line comprising a set of disparate machines; at least one processor; and a computer-readable storage device storing instructions which, when executed by the at least one processor, cause the at least one processor to be configured to: detect a problem with one machine in the production line to yield a detected problem; based on the detected problem, determine, via an artificial intelligence model or rule chain and for a respective machine on the production line, a respective correct degraded mode for the respective machine in order to maintain an original production line output or a degraded production line output; and issue a series of commands such that the respective machine adjusts to the respective correct degraded mode or the respective machine is bypassed and the production line operates to produce either the original production line output or the degraded production line output.
Clause 12. The system of clause 11, wherein the at least one processor is further configured to: intercept data from a data source comprising one or more of a sensor, a device or a communication between a programmable logic controller (PLC), and a human-machine interface (HMI) to enhance fault detection capabilities.
Clause 13. The system of clause 11 or any previous clause, wherein the at least one processor is further configured to generate alerts by harmonizing and aggregating data from a single sensor or multiple sensors to improve fault detection accuracy.
Clause 14. The system of clause 11 or any previous clause, wherein the at least one processor is further configured to: use an artificial intelligence model to determine an appropriate degraded mode for each machine in a production line, ensuring consistent operation across disparate equipment.
Clause 15. The system of clause 11 or any previous clause, wherein the at least one processor is further configured to: initiate repair or preventative maintenance by dispatching a service technician based on an alert, thereby reducing downtime and improving efficiency.
Clause 16. The system of clause 11 or any previous clause, wherein the respective correct degraded mode involves reducing a speed or output of a machine to prevent potential failure, thereby extending an operational life of equipment.
Clause 17. The system of clause 11 or any previous clause, wherein the at least one processor is further configured to: reconfigure a whole production line comprising disparate equipment to run in a production line degraded mode, ensuring minimal disruption to production output.
Clause 18. The system of clause 11 or any previous clause, wherein receiving data comprises using communication protocols such as Message Queues Telemetry Transport (MQTT), Modbus Transmission Control Protocol/Internet Protocol (TCP/IP), Object Linking and Embedding Process Control Unified Architecture (OPC UA), or other communications protocol.
Clause 19. The system of clause 11 or any previous clause, wherein the at least one processor is further configured to: generate a data payload on-premises via one or more of a machine, a broker, an edge controller, and a gateway; and transmit the data payload to an external server to enable a case to be opened and a service technician to be dispatched.
Clause 20. The system of clause 11 or any previous clause, wherein the at least one processor is further configured to: capture data indicative of an alert or error on a machine; and generate a data payload on-premises based on this data.
Clause 21. A computer-readable storage device storing instructions which, when executed by at least one processor, cause the at least one processor to be configured to: detect a problem with one machine in a production line to yield a detected problem; based on the detected problem, determine, via an artificial intelligence model or rule chain and for a respective machine on the production line, a respective correct degraded mode for the respective machine in order to maintain an original production line output or a degraded production line output; and issue a series of commands such that the respective machine adjusts to the respective correct degraded mode or the respective machine is bypassed and the production line operates to produce either the original production line output or the degraded production line output.
Clause 22. The computer-readable storage device of clause 21, wherein the at least one processor is further configured to: intercept data from a data source comprising one or more of a sensor, a device or a communication between a programmable logic controller (PLC), and a human-machine interface (HMI) to enhance fault detection capabilities.
Clause 23. The computer-readable storage device of clause 21 or any previous clause, wherein the at least one processor is further configured to generate alerts by harmonizing and aggregating data from a single sensor or multiple sensors to improve fault detection accuracy.
Clause 24. The computer-readable storage device of clause 21 or any previous clause, wherein the at least one processor is further configured to: use an artificial intelligence model to determine an appropriate degraded mode for each machine in a production line, ensuring consistent operation across disparate equipment.
Clause 25. The computer-readable storage device of clause 21 or any previous clause, wherein the at least one processor is further configured to: initiate repair or preventative maintenance by dispatching a service technician based on an alert, thereby reducing downtime and improving efficiency.
Clause 26. The computer-readable storage device of clause 21 or any previous clause, wherein the respective correct degraded mode involves reducing a speed or output of a machine to prevent potential failure, thereby extending an operational life of equipment.
Clause 27. The computer-readable storage device of clause 21 or any previous clause, wherein the at least one processor is further configured to: reconfigure a whole production line comprising disparate equipment to run in a production line degraded mode, ensuring minimal disruption to production output.
Clause 28. The computer-readable storage device of clause 21 or any previous clause, wherein receiving data comprises using communication protocols such as Message Queues Telemetry Transport (MQTT), Modbus Transmission Control Protocol/Internet Protocol (TCP/IP), Object Linking and Embedding Process Control Unified Architecture (OPC UA), or other communications protocol.
Clause 29. The computer-readable storage device of clause 21 or any previous clause, wherein the at least one processor is further configured to: generate a data payload on-premises via one or more of a machine, a broker, an edge controller, and a gateway; and transmit the data payload to an external server to enable a case to be opened and a service technician to be dispatched.
Clause 30. The computer-readable storage device of clause 21 or any previous clause. wherein the at least one processor is further configured to: capture data indicative of an alert or error on a machine; and generate a data payload on-premises based on this data.

What is claimed is:

1. A method comprising:
detecting a problem with one machine in a production line comprising a set of disparate machines to yield a detected problem;
based on the detected problem, determine, via an artificial intelligence model or rule chain and for a respective machine on the production line, a respective correct degraded mode for the respective machine in order to maintain a constant and a degraded production line output; and
issuing a series of commands, either automatically or through guided manual intervention, such that a respective machine adjusts to the respective correct degraded mode and the production line operates to produce the degraded production line output.

2. The method of claim 1, further comprising:
intercepting data from a communication between a programmable logic controller, sensor or other component and a human-machine interface to enhance fault detection capabilities.

3. The method of claim 1, wherein an alert is generated by harmonizing and aggregating data from a single sensor or multiple sensors to detect a fault, thereby improving an accuracy of fault detection.

4. The method of claim 1, further comprising using an artificial intelligence model or rule chain to determine an appropriate degraded mode for each machine in a production line, ensuring consistent operation across disparate equipment.

5. The method of claim 1, wherein a repair or preventative maintenance is initiated by dispatching a service technician based on an alert, thereby reducing downtime and improving efficiency.

6. The method of claim 1, wherein the respective correct degraded mode involves reducing a speed or output of a machine to prevent potential failure, thereby extending an operational life of equipment.

7. The method of claim 1, further comprising reconfiguring a whole production line comprising disparate equipment to run in the respective correct degraded mode, ensuring minimal disruption to production output.

8. The method of claim 2, wherein the data is intercepted via a communication protocol selected from Message Queues Telemetry Transport (MQTT), Modbus Transmission Control Protocol/Internet Protocol (TCP/IP), Object Linking and Embedding Process Control Unified Architecture (OPC UA), or other communications protocol.

9. The method of claim 1, further comprising generating a data payload on-premises via one or more of a machine, a broker, an edge controller, and a gateway, and transmitting the data payload to an external server to enable a case to be opened and a service technician to be dispatched.

10. The method of claim 1, further comprising capturing, on a machine and via a device, data indicative of an alert or error, and generating, based on the data indicative of the alert or the error, a data payload on-premises.

11. A system comprising:
a production line comprising a set of disparate machines;
a processor; and
a computer-readable storage device storing instructions which, when executed by the processor, cause the processor to be configured to:
detect a problem with one machine in the production line to yield a detected problem;
based on the detected problem, determine, via an artificial intelligence model or rule chain and for a respective machine on the production line, a respective correct degraded mode for the respective machine in order to maintain a constant and a degraded production line output; and
issue a series of commands, either automatically or through guided manual intervention, such that the respective machine adjusts to the respective correct degraded mode and the production line operates to produce the degraded production line output.

12. The system of claim 11, further comprising a communication protocol to intercept data from a data source comprising one or more of a sensor, a device a communication between a programmable logic controller to a human-machine interface, enhancing fault detection capabilities.

13. The system of claim 11, wherein an alert is generated by harmonizing and aggregating data from a single sensor or multiple sensors to detect a fault, thereby improving an accuracy of fault detection.

14. The system of claim 11, further comprising an artificial intelligence model or rule chain to determine an appropriate degraded mode for each machine in a production line, ensuring consistent operation across disparate equipment.

15. The system of claim 11, wherein a repair or preventative maintenance is initiated by dispatching a service technician based on an alert, thereby reducing downtime and improving efficiency.

16. The system of claim 11, wherein the respective correct degraded mode involves reducing a speed or output of a machine to prevent potential failure, thereby extending an operational life of equipment.

17. The system of claim 11, further comprising reconfiguring a whole production line comprising disparate equipment to run in the respective correct degraded mode, ensuring minimal disruption to production output.

18. The system of claim 12, wherein the data is intercepted via a communication protocol selected from Message Queues Telemetry Transport (MQTT), Modbus Transmission Control Protocol/Internet Protocol (TCP/IP), Object Linking and Embedding Process Control Unified Architecture (OPC UA), or other communications protocol.

19. The system of claim 11, further comprising generating a data payload on-premises via one or more of a machine, a broker, an edge controller, and a gateway, and transmitting the data payload to an external server to enable a case to be opened and a service technician to be dispatched.

20. The system of claim 11, further comprising capturing, on a machine and via a device, data indicative of an alert or error, and generating, based on the data indicative of the alert or the error, a data payload on-premises.

21. A computer-readable storage medium storing instructions which, when executed by at least one processor, cause the at least one processor to be configured to:
detect a problem with one machine in a production line to yield a detected problem;
based on the detected problem, determine, via an artificial intelligence model and for a respective machine on the production line, a respective correct degraded mode for the respective machine in order to maintain a constant and a degraded production line output; and
issue a series of commands such that the respective machine adjusts to the respective correct degraded mode and the production line operates to produce the degraded production line output.
